(19) United States
(12) Patent Application Publication
(10) Pub. No.: US 2015/0039691 A1
(43) Pub. Date: Feb. 5, 2015

(54) System and Methods for Dynamic Floor Control in Group Communications

(71) Applicant: QUALCOMM Incorporated, San Diego, CA (US)

(72) Inventors: Sandeep Sharma, San Diego, CA (US); Amit Goel, San Diego, CA (US); Mohammed Ataur Rahman Shuman, San Diego, CA (US)

(73) Assignee: QUALCOMM Incorporated, San Diego, CA (US)

(21) Appl. No.: 13/958,906

(22) Filed: Aug. 5, 2013

(51) Int. Cl. H04L 29/06

(52) U.S. Cl. CPC H04L 65/403
USPC 709/204

(57) ABSTRACT

Dynamic floor control in group communications may include allocating floor time to participants according to a floor control function. To determine the amount of floor time to allocate to each participant, an embodiment floor control function may factor in parameters including the number of active participants in the group communication, the overall likeability of each participant, and the popularity ranking for each participant. In an embodiment, parameters such as overall likeability may be based on votes received from other participants. Parameters may be updated during the group communication to adjust participants' floor time. If a participant is granted the floor or speaks, a countdown timer may be started that decrements the participant's remaining floor time until the participant releases the floor or runs out of floor time. Once the countdown timer expires, the participant may be denied the floor and/or may no longer speak in the group communication.

### BACKGROUND

In wireless telecommunications, group communication systems may accommodate a large group of participants who wish to share information in a single session or call. For example, push-to-talk/push-to experience (“PTT/PTX”) sessions or conference calls may provide a group of participants a convenient forum in which they may communicate to coordinate business and social activities. However, with the ability to accommodate a large number of participants, as well as to allow new participants to join and/or existing participants to invite others, conducting a group communication session in a productive and organized manner may be challenging.

In conventional PTT/PTX half-duplex communications, for example, the ability of a participant to speak may be limited by floor control mechanisms. Further, in full-duplex conference calls, floor control may be desirable to prevent participants from talking over one another, since the users often cannot see one another, and/or participant to prevent a participant from introducing background noise disturbances to the call that compete with the speaker. While it may be possible to solve these issues by imposing a uniform time limit or automatic expiration of floor time for all participants in a communication group, such action may also be too restrictive given the variations in group calls (e.g., participants joining or leaving, purpose of call requiring unequal participation, etc.).

### SUMMARY

The various embodiments may include allocating an initial floor time to each active participant in the plurality of active participants, determining a group size for the plurality of active participants, determining a likeability rating for at least one active participant of the plurality of active participants, and adjusting the floor time allocated to the at least one active participant based on the determined group size and the determined likeability rating. The floor times allocated to the plurality of active participants may add up to the total amount of time for the group communication, or may add up to less than the total amount of time for the group communication.

Embodiment methods may also include receiving a vote from at least one other active participant in which the received vote comprises a favorability or likeability vote (e.g., “up” or “down”) of associated with the at least one active participant, determining an aggregate likeability based on all received votes, (e.g., the number of received “up” or favorable votes minus the number of “down” or unfavorable votes) associated with the at least one active participant, and determining a likeability adjustment for the at least one active participant based on the aggregate likeability determination. The received votes may further include an amount of time by which to increase or decrease the floor time allocated to the at least one active participant.

Embodiment methods may further include determining an aggregate change in floor time allocated to the at least one active participant by combining the increase and decrease amounts of time indicated in all of the received votes, and adjusting the floor time allocated to the least one active participant based on the aggregate change in floor time. In received votes, the amount of time by which to increase floor time allocated to the at least one active participant may represent time that is presently allocated to the at least one other participant, or to a global floor time bank assigned to the group communication. In received votes, the amount of time by which to decrease floor time is allocated to the at least one active participant may represent time that is presently allocated to the at least one active participant and that may be transferred to the global floor time bank. In an embodiment, a sum of the initial floor times allocated to each active participant may be less than a total amount of time for the group communication, and a difference between the sum and the total amount of time for the group communication may be allocated to the global floor time bank assigned to the group communication.

Embodiment methods may also include applying the determined likeability adjustment to the initial floor time allocated to the at least one active participant. Embodiment methods may further include retrieving a popularity ranking associated with the at least one active participant. Such a popularity ranking may be based on accumulated likeability ratings for the at least one active participant from previous group communications.

### BRIEF DESCRIPTION OF THE DRAWINGS

The accompanying drawings, which are incorporated herein and constitute part of this specification, illustrate embodiments of the invention, and together with the general description given above and the detailed description given below, serve to explain the features of the invention.

FIG. 1 is a communication system diagram of a network suitable for use with the various embodiments.

FIG. 2A is a functional block diagram of a wireless communications device suitable for use with various embodiments.

FIG. 2B is a software architecture diagram illustrating software layers of a group application client that may include push-to-talk (PTT) functionality.

FIG. 3 is a communication system diagram of an example group communication system for a plurality of wireless communications devices.

FIG. 4 is a component block diagram of a group communication server suitable for use with the various embodiments.

FIG. 5 is a data structure diagram illustrating example parameter values that may be tracked during a group communication for use in a floor control function.

FIG. 6 is a process flow diagram illustrating an embodiment method for implementing a floor control function to adjust at least one participant's effective floor time in a group communication.

FIG. 7 is a process flow diagram illustrating an embodiment method for handling floor control between participants during a group communication.

FIGS. 8A-8F are illustrations of screenshots of a touchscreen display of an embodiment group communication interface for participant voting.

FIG. 9 is a component block diagram of a mobile device suitable for use with the various embodiments.

FIG. 10 is a component block diagram of a laptop computer mobile device suitable for use with the various embodiments.

FIG. 11 is a component block diagram of a server suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The terms “mobile communication device”, “wireless device”, “mobile device”, “wireless communications device”, “smartphone”, and “computing device” are used interchangeably herein to refer to any one or all of cellular telephones, smartphones, personal or mobile multi-media players, personal data assistants (PDA's), laptop computers, tablet computers, smartbooks, palm-top computers, wireless electronic mail receivers, multimedia Internet enabled cellular telephones, wireless gaming controllers, and similar personal electronic devices which include a programmable processor and memory and transmit/receive circuitry configured to transmit and receive voice and/or other data over a wireless communication link.

The terms “group communication” and “group call” are used interchangeably in the following descriptions to refer to a type of communication link functionality that allows a user to simultaneously transmit from a calling device to one or more receiving devices without requiring an existing connection, including, but not limited to, push-to-talk (PTT) communications, such as push-to-talk over cellular (PoC) transmissions, push to transmit (PTX), and other push-to-experience communications including, but not limited to, push-to-content transmissions, push-to-PC calls, push-to-SMS messages, push-to-locate GPS signals, etc. Group communications may also refer to multi-party conference calls, including multi-media conferencing. In the various embodiments, such communications may be half-duplex or full-duplex communications, and may be between a calling device and one or multiple receiving devices. Since PTT communication is a well known type of group communication, the terms “PTT,” “PTX” and “PTT/PTX” are used herein in the description of the various embodiments for ease of reference. However, the use of “PTT,” “PTX” and “PTT/PTX” in describing the various embodiments is not intended to limit the nature of the group communication, the methods or devices recited in the claims to PTT and/or or PTX to the exclusion of other types of group communication unless specifically recited in the claims themselves.

The terms “floor time” and “effective floor time” are used herein to refer to an amount of time during which a participant in a group communication may be permitted to control the floor, i.e., in a half-duplex group session, and/or the amount of time during which the participant may be entitled to speak/transmit data, either exclusively or in conjunction with other participants, during a full-duplex multi-party conference call,

Existing group communication systems may have many advantages over traditional cellular call systems. For example, PTT/PTX communications may have faster call setup times, e.g., setup times ideally in the range of 1 second as opposed to cellular voice channels that can take more than 5 seconds to establish. In some arrangements, the PTT/PTX speaker may have the “floor” where no other group member can speak while the speaker is speaking. Generally speaking, the group communication system may use standard voice-over Internet protocol (VoIP) technologies. Voice information may be sent in digital form over IP-based data networks. In PTT/PTX communications, instead of using the standard cellular infrastructure a call may be formed by combining separate point-to-point connections between each IP endpoint in the network.

Various embodiment group communications may use the session initiation protocol (SIP), a widely-used signaling protocol for voice over IP (VoIP) communications in which transfer of packets occurs using the Real-time Transport Protocol (RTP). RTP, and the associated RTP control protocol (RTCP), are protocols that are well known in the art, respectively, for transmitting real-time data (e.g., audio or video streams) and maintaining RTP session quality.

The various embodiments provide floor control for group communications through a floor grant function that enables participants to determine who receives or is denied the floor during group communications. In various embodiments, the floor grant function may be a democratic mechanism in which participants vote for and yield floor time to others. In various embodiments, the floor grant function may involve dynamically computing and adjusting a participant's allowed floor time in a group communication using parameters that include input from other participants in the group.

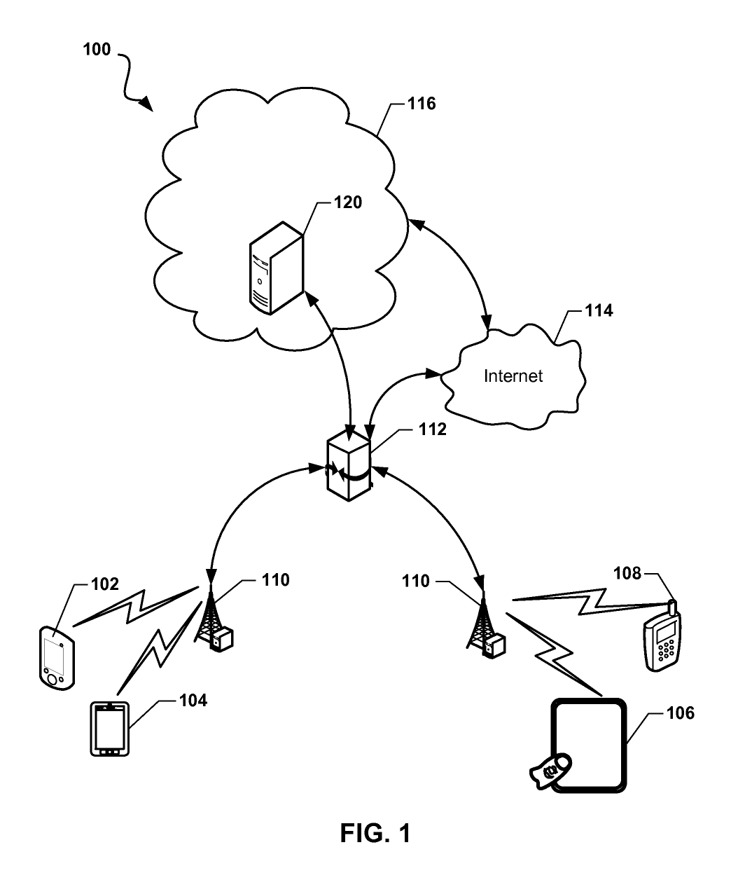

The various embodiments may be implemented within a variety of wireless communication systems 100, an example of which is illustrated in FIG. 1. The communication system 100 may include a plurality of mobile devices 102, 104, 106, 108, which may be configured to communicate via cellular telephone network, a radio access network, WiFi network, WiMAX network, and/or other well known technologies. Mobile devices 102, 104, 106, 108 may be configured to receive and transmit voice, data and control signals to and from a base station 110 (e.g., base transceiver station) which may be coupled to a controller (e.g., cellular base station, radio network controller, service gateway, etc.) operable to communicate the voice, data, and control signals between mobile devices and to other network destinations. The base station 110 may communicate with an access gateway 112, which may be a packet data serving node (PDSN), for example, and which may serve as the primary point of entry and exit of wireless device traffic. The access gateway 112 may be implemented in a single computing device or in many computing devices, either within a single network or across a wide area network, such as the Internet.

The access gateway 112 may forward the voice, data, and control signals to other network components as user data packets, provide connectivity to external packet data networks, manage and store contexts (e.g. network internal routing information, etc.) and act as an anchor between different technologies (e.g., 3G and 4G systems). The access gateway 112 may also coordinate the transmission and reception of data to and from the Internet 114, and the transmission and reception of voice, data and control information to and from an external service network connected to the Internet 114 and other base stations 110 and wireless receivers 102, 104, 106, 108.

The access gateway 108 may connect the receiver devices 102 to a service network 116. The service network 116 may control a number of services for individual subscribers, such as management of billing data and selective transmission of data, such as multimedia data, to a specific receiver device 102, 104, 106, 108. The service network 116 may be implemented in a single computing device or in many computing devices, either within a single network or across a wide area network, such as the Internet 114. The service network 116 may typically include one or more servers 120, such as a group communication server described in further detail below.

The mobile device may be, for example, a smartphone 102, 104, a tablet computer 106, a cellular telephone 108, or any other suitable mobile device. In general, the mobile devices may include a platform that can receive and execute software applications, data and/or commands transmitted over the wireless network that may ultimately come from the service network 116, the Internet 114 and/or other remote servers and networks. The mobile device may include a transceiver operably coupled to a processor, which may be an application specific integrated circuit (ASIC), microprocessor, logic circuit, or other data processing device. The processor may execute an application programming interface (“API”) layer that interfaces with any resident programs in an internal memory of the mobile device. The internal memory may be comprised of read-only or random-access memory (RAM and ROM), EEPROM, flash cards, or any memory common to computer platforms. The mobile device may also include a local database that stores applications not actively used in memory. The local database is typically a flash memory cell, but may be any secondary storage device as known in the art, such as magnetic media, EEPROM, optical media, tape, soft, or hard disk, or the like. The processor may also be operably coupled to external devices such as an antenna, microphone, speaker, display, keypad or other user input device, such as a touchscreen device, as is known in the art.

In conventional wireless communication systems, a group communication session between two or more mobile devices may be arbitrated by a group communication server or a network of such servers (e.g., collectively illustrated by server 120 in FIG. 1). The subscribers to a particular group communication service (e.g., a push-to-talk (PTT) service, a push-to-transfer (PTX) service, etc.) may thereby be permitted to communicate with other subscribers of the same service with messages being exchanged either through, or at the control of, the group communication server 120. In the case of a group audio session, this means audio packets may be transmitted to the group communication server 120 via the wireless network from one of the subscriber devices (e.g., mobile devices 102, 104, 106, 108), and the server 120 may forward the audio packets to one or more other subscriber devices actively participating in the group communication session. Likewise, for group sessions involving other types of media (e.g., text messages, multimedia messages including video and/or audio, etc.), other types of data packets may be exchanged between mobile devices of group members, or subscribers, during the session.

In various embodiments, the group communication server 120 may perform arbitration functions between competing demands of the various mobile devices 102, 104, 106, 109 for use of communication channels over the wireless network. For example, in response to a request from wireless communications device 102 to communicate with one or more other target devices in a communication group, including all other devices in the group, the server 120 may establish a communication channel between the requesting device 102 and all or a portion of the requested target devices in the group. The server 120 may grant control of the “floor” to the requesting mobile device 102 using a floor control function according to the various embodiments described herein.

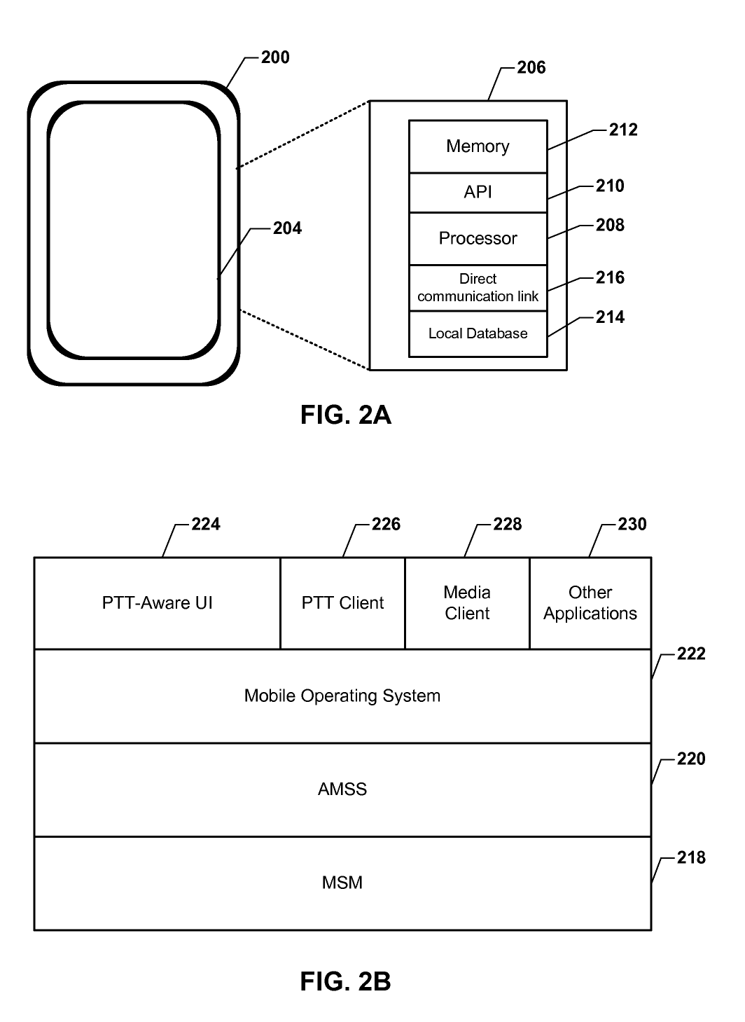

FIG. 2A illustrates an example wireless device 200 that may be part of the group of wireless communications devices 102, 104, 106 shown in FIG. 1. Wireless device 200 may include software and/or hardware to provide a group communication (e.g. “Push-To-Talk” (PTT)) function that opens the direct communication to a target device, e.g., an endpoint associated with an IP address. In various embodiments, the wireless communications device 200 may provide group communication functionality using only software and existing device hardware (e.g., a conventional user interface/display, such as a keypad or touchsceen interface). In the various embodiments, the wireless device may have a touchscreen interface/display 204.

In various embodiments, the wireless communications device 200 may include a computer platform 206 that can handle voice and data packets, execute software applications, and transmit information across a wireless network. The computer platform 206 includes, among other components, a processor 208 such as an application-specific integrated circuit (“ASIC”) or a RISC processor such as those that implement the ARM architecture. The processor 208 is typically installed at the time of manufacture of the wireless communications device 200 and is not normally upgradeable. The processor 208 or other processor executes an application programming interface (“API”) layer 210, which includes the resident application environment, and may include the operating system loaded on the processor 208. The resident application environment interfaces with any resident programs in the memory 212, e.g., a computer readable storage medium of the wireless communications device 200.

As shown in FIG. 2A, the wireless communications device 200 may be a wireless communication telephone, with a graphics display 204, but may also be any wireless device with a computer platform 206 as known in the art, such as a personal digital assistant (PDA), a pager with a graphics display 204, or even a separate computer platform 206 that has a wireless communication portal, and may otherwise have a wired connection to a network or the Internet. Further, the memory 212 may be comprised of read-only or random-access memory (RAM and ROM), EPROM, EEPROM, flash cards, or any memory common to computer platforms. The computer platform 206 may also include a local database 214 for storage of software applications not actively used in memory 212. The local database 214 may be comprised of one or more flash memory cells, but may be any secondary or tertiary storage device as known in the art, such as magnetic media, EPROM, EEPROM, optical media, tape, or soft or hard disk. The graphics display 204 may present not only information about the ongoing group call, but also the information about the data package in order to generate a preview as is more fully described herein.

The computer platform 206 may also include a direct communication interface 216 that is configured to open a direct communication channel. The direct communication interface 216 may also be part of the standard communication interface for the wireless communications device 200 which ordinarily carries the voice and data transmitted to and from the wireless communications device 200. The direct communication interface 116 typically is comprised of hardware as is known in the art.

FIG. 2B is a software architecture diagram of software layers of a group application client that can include, but is not limited to, PTT functionality and data package functionality. While the embodiment shown in FIG. 2B is implemented in a PTT session, the present system can be utilized in any group communication session setup for transmission of voice and/or data substantially simultaneously among group members. In an embodiment, the computer platform 206 in the wireless communications device environment may include a series of software “layers” developed on top of a baseband chipset and system software such as the Wireless communication Station Modem (MSM) 218 and the Advanced Wireless communication Subscriber Software (AMSS) 220, developed by QUALCOMM Incorporated. In this example, the underlying MSM chipset may implement the software protocol stack for the entire suite of CDMA communication technologies that include CDMA2000 1x and CDMA2000 1xEV-DO. In this example the AMSS 220 may be configured to support a wireless communication operating system layer 222, which in an embodiment is BREW® also developed by QUALCOMM. The wireless communication operating system layer 222 may provide an application programming interface for chip or device-specific operations, while providing an isolation layer that eliminates direct contact to the AMSS 220 and any OEM software on the computer platform. The wireless communication operating system layer 222 may enable application development that uses wireless communications device features without having to rewrite the application each time a new release of the device-specific software is released.

In this example the wireless communication operating system 222 may include a PTT client 226 that is configured to offer access to PTT services through an external interface, here shown at a PTT-aware UI 224. The PTT client 226 may include all the functions required to enable wireless communication operating system 222 applications, such as the media client 228. In an embodiment, the PTT client 226 may maintain access to PTT services, respond to communication requests, process all PTT-aware wireless communication operating system applications requests for PTT services, process all outgoing PTT requests, collect and package vocoder packets for originating PTT talk spurts, and parses packets of vocoder data for terminated PTT talk spurts.

In various embodiments, the computer platform 106 in the wireless communications device environment may include a media client 228, which may be a wireless communication operating system-based application that extends PTT services for access to media types other than the traditional half duplex voice communications (VoIP-PTT media). The media client 228 may provide access to media services through an external interface such as a media aware API that may be developed entirely as a wireless communication operating system-based application or used in combination with an AMSS 220 interface. The media client 228 may service requests from the user and inform the user of the result of any group-directed media request. The media client 228 may additionally be configured to handle incoming notifications that indicate there is data package to download from a media server and described in more detail below. For example, the media client 228 may be configured in one embodiment to download data packages immediately or in other embodiments the media client 228 may be configured to download the data package at a predetermined time period, e.g., at 10:00 pm daily, or it may be configured to prompt the user via the PTT UI 224 to determine whether and/or when to download the file. Other applications 230, which may be push-to-talk or other applications than can receive and transmit data across the group communication channel, may also be resident on the platform.

In some embodiments, the software to enable PTT functionality in the wireless communications device 100 may be pre-installed in the device during device manufacture. In other embodiments, at least a portion of the software providing PTT functionality may be downloaded to the device 100 by the end-user. In some embodiments, the PTT software may be a downloadable application (e.g., a mobile app).

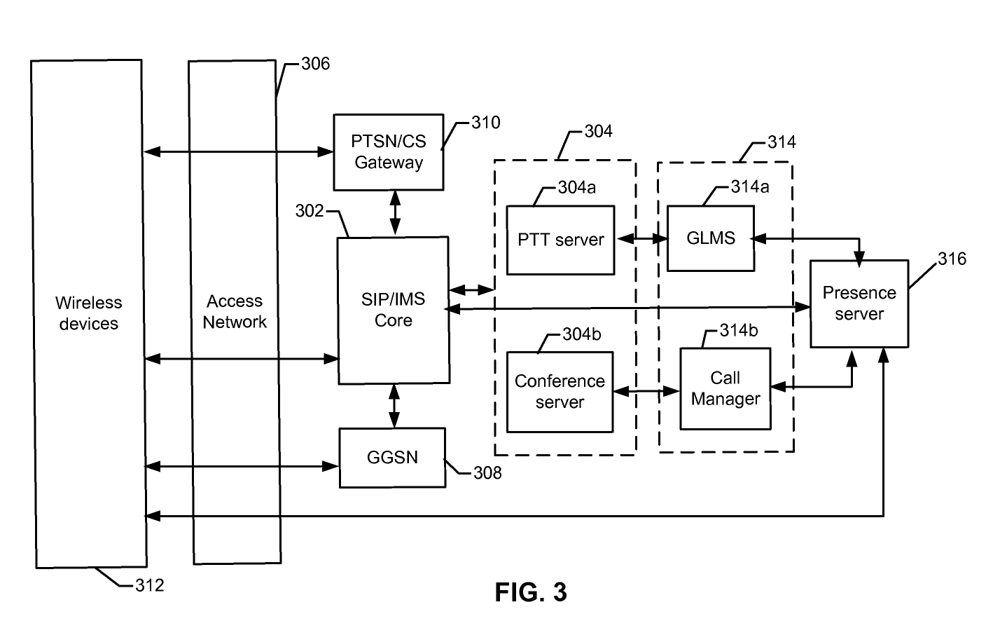

FIG. 3 illustrates functional components of an embodiment group communication system 300 configured to provide half-duplex and/or full-duplex group communications. In various embodiments, components of a group communication system 300 may include an IP Multimedia Subsystem (IMS)/Session Initiation Protocol (SIP) core 302, at least one group communication server 304, an access network 306, at least one Gateway GPRS support node (GGSN) 308, and a Public Telephone Switched Network (PTSN)/Circuit switched (CS) gateway 310.

The IMS/SIP core 302 may be an architectural framework for delivering IP multimedia services, and allowing support and control of SIP-based applications. Characteristics and details that define the IMS/SIP core 302 are described in GSM specifications, including, but not limited to, 3GPP TS 24.229 version 12.0.0 Release 12. In the IMS/SIP core 302, SIP Application servers (AS) may host and execute services, such as various half- and full-duplex group communication services.

In various embodiments, an IMS/SIP core 302 may connect to a public or private IP network, and may provide packet-switched group communication services to wireless devices 312.

Wireless devices 312 may register on the IMS/SIP core 302 through a variety of access networks 306, which may be supported by nodes and gateways provided in the group communication system 300. For example, a wireless device 312 configured to access a GPRS network may connect with the IMS/SIP core 302 through a gateway GPRS support node (GGSN) 308. The GGSN 308 may provide inter-networking functions between the GPRS network and external packet switched networks, including those that use IP. In another example, a wireless device 312 configured to use a circuit switched (CS) access network may be able to connect with the IMS/SIP core 302 through the PTSN/CS gateway 310.

In addition to IP connectivity, the IMS/SIP core 302 may provide authentication and authorization services to wireless devices 312. In an embodiment, communications between wireless devices 312 and the IMS/SIP core 302 may use SIP, which may be transported using the User Datagram Protocol (UDP). In various embodiments the IMS/SIP core 302 may also route SIP signaling messages, for example, call set-up messages, between wireless devices 312 (through one or access network(s) 306) and at least one group communication server 304. Further, the IMS/SIP core 302 may support the transport of talk bursts, floor control, and link quality messages between the wireless devices 312 and at least one group communication server 304.

In various embodiments, at least one group communication server 304 may provide services needed for group call sessions. In some embodiments, different types of group communications may share a common group communication server 304 (i.e., a single entity that handles all group communications). In other embodiments, each type of group communication may be associated with a physically or logically separate server (e.g., a PTT/PTX server 304a, a multi-party conference server 304b, etc.) For example, in an embodiment PTT/PTX group communication, a group communication server such as PTT/PTX server 304a may provide SIP session handling, group session handling, access control, floor control functionality, participant identification and/or media distribution. The PTT/PTX server 304a may function as an endpoint for SIP, Real-Time Transport Protocol (RTP) and/or Real Time Transport Control Protocol (RTCP) signaling. As previously stated, SIP may used for signaling to establish, modify and terminate communication sessions. Additionally, RTP may be used to transport voice packets in a PTT/PTX group call, and RTCP may be used to perform floor control during PTT/PTX sessions.

The PTT/PTX server 304a may communicate with a group management server 314, such as a Group and List Management Server (GLMS) 314a. The GLMS 314a may be responsible for managing group lists, contact lists, and access lists associated with each wireless device 312. A group list may be a list of groups to which a user belongs, and each group may be a collection of PTT/PTX user identities defined by a participant creating the group. A user creating the group may be the group owner and may modify or delete the group. Each group may be assigned a SIP address that may serve as the group identifier. Additionally, the GLMS 314a may manage one or several contact lists for each user, which may be accessible by wireless devices 312 and may include addresses/identities for other users or groups. Further, the GLMS 314a may manage an access list for each wireless device 312, which may define access restrictions to control who is allowed to initiate instant talk sessions or other group communications with the user. An access list may contain wireless device 312 user defined identities of other PTT/PTX users or groups. In an embodiment, a wireless device 312 user may have one blocked identities list and one granted identities list.

In some embodiments, communications between wireless devices 312 and the GLMS 314a to manage the groups, contact lists and access lists, as well as indications (e.g., Do-not-disturb) that may be set by wireless devices 312, may take place using HTTP/XML. In addition, the GLMS 314a may communicate with at least one group communication server, for example PIT/PTX server 304a, enabling the PTT/PTX server 304a to retrieve the groups, contacts, access lists, and indications for each participant.

In various embodiments, in addition or in the alternative to PTT/PTX communications, the group communication system 300 may include components that provide full-duplex multi-party conference calls and/or data sessions. Such components may include, but are not limited to, a conference server and a call manager. As discussed above, in some embodiments PTT/PTX communications as well as multi-party conference calls may share a common group communication server 304, while in other embodiments each type of group communication may be handled by separate group communications server, for example, conference server 304b for multi-party conference calls. Similarly, in some embodiments PTT/PTX communications and conference calls may share a common management server 314, while in other embodiments each type of group communication may be associated with a physically or logically separate management server (e.g., GLMS 314a, call manager 314b, etc.)

In various embodiments, conference server 304b may allow participants to communicate substantially simultaneously for a multimedia conference call. In an embodiment, conference server 304b may provide conference functionality for packet-switched networks. In various embodiments the conference server may include a conference bridge, which may provide conference functionality in CS networks such as the PTSN.

The conference server 304b may implement one or more control or signaling protocols. A call manager 314b may be configured to connect with the conference server 304b part of the group communication system 300. In an embodiment, the Call Manager 314b may create, access and update information about participants in the conference calls. The Call Manager 314b may also track all active VoIP network components, including wireless devices, gateways, conference bridges, transcoding resources, etc. In various embodiments the call manager may monitor conference call event information, for example, context information (e.g., call duration, time remaining in a call, time extension procedures, etc.), participant information (e.g., number of participants on a call, time of joining or leaving a call, participant location, identification of an active speaker and/or leader of the call, etc.), and/or supplemental information (e.g., call agenda, presentation materials, slides, audio recordings, video recordings, documents, etc.).

In addition to components that provide PTT/PTX and/or conference communications among a group of participants, the group communication system 300 may include presence server 316 accessible to both the GLMS 314a and Call Manager 314b, and which exchanges signaling with the IMS/SIP core 302. The presence server 316 may manage presence information for the wireless devices 312, and may be responsible for combining presence-related information for multiple devices into a single presence document. The presence information may be used by participants to determine the availability and willingness of other participants. In various embodiments, the IMS/SIP core 302 may upload registration status of wireless device users to the presence server 316, which may in turn disseminate presence information to the wireless devices 312. Further, a Do-not-Disturb status and/or granted/blocked access lists may be uploaded from the GLMS 314a and/or Call Manager 314b to the presence server 316.

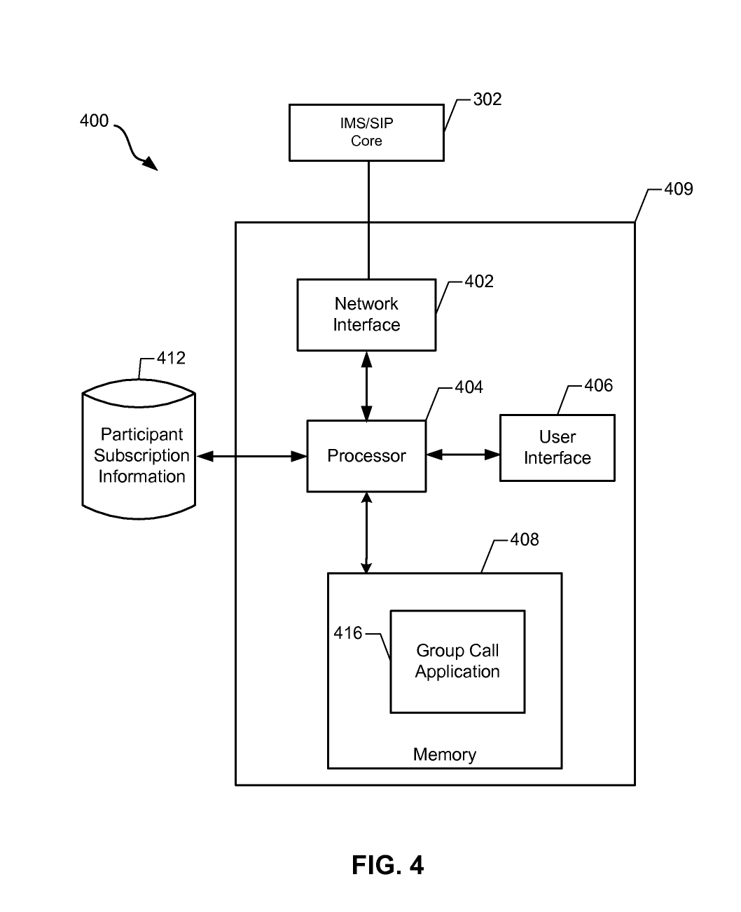

FIG. 4 illustrates components of an embodiment group communication server 400 for managing information and supporting group communications, such as a PTT/PTX server 304a and/or a conference server 304b, discussed above with respect to FIG. 3. The group communication server 400 may include a network interface 402 that may be wired and/or wireless for communicating over the IMS/SIP core 302. A processor 404 may be connected to the network interface 402, a user interface 406, and memory 408. The processor 404 may include one or more microprocessors, microcontrollers, and/or digital signal processors that provide processing functions, as well as other calculation and control functionality. The processor 404 may access memory 408 for reading/writing data and/or software instructions for executing programmed functionality. The memory 408 may be onboard the processor 404 (e.g., within the same IC package 409), and/or the memory may be external memory to the processor and functionally coupled over a data bus.

A number of software modules and/or data tables may reside in the memory 408 and be utilized by the processor 404, including but not limited to, a group call application 416, which may be configured for PTT/PTX sessions and/or conference call sessions. The group communications server 400 may be further configured to receive and store participant voting information in a data storage system 412. The data storage system 412 may be an external repository that may be connected via a wired or wireless network to the processor 404 of the group communication server 400.

The various embodiments may improve current floor control arbitration in group communications through a democratic floor control function. Specifically, the group communication systems in the various embodiments may dynamically assign floor time to participants based on a plurality of democratically determined parameters. Using a weighted combination of these parameters, a floor control function may be implemented as a running algorithm that determines a net amount of time for which each participant may have the floor (such as in a PTT/PTX communication and/or in a conference call) and/or a net degree of restriction on each participant's ability to contribute to the conversation (such as in a conference call).

At the beginning of a group communication, floor time may be distributed among active participants based on the size of the group. In one embodiment, the initial floor time allocation may divide the time equally between the participants. In other embodiments floor time may be initially unequally distributed based on other factors, for example, differences between participants' popularity ranking at the beginning of the group communication.

In the various embodiments, the multiple input parameters for an example floor control function may include, for example, the number of active participants in the group call, a likeability rating from other participants in the group call, and a popularity rank from the participant's likeability rating history. In an embodiment, these parameters may be tracked at the group communication server. In an alternative embodiment, some or all of these parameters may be tracked by each participant's wireless device and uploaded to a group communication server.

Specifically, in an embodiment a participation parameter (x) may dynamically influence floor time in a manner that is inversely proportional to the size of the communication group. The size of the group may fluctuate throughout the call, for example, due to participants joining and exiting the group communication. For example, a participant's initially-allocated floor time may be reduced in response to an increase in the number of participants, and/or may be increased in response to a reduction in the number of participants (e.g., when some participants hang up or log out). In an embodiment, the participation parameter may be based on a subset of the total group size, for example, a count of the number of active participants in the group. In another embodiment, the participation parameter may be based on a total size of the group, such as a count of all participants, including both active and inactive participants. In another embodiment, the participation parameter may be based on both the number of active participants and the total number of participants, such as such as a weighted count of the number of active participants compared to a count of all participants. For example, a participation parameter may provide a greater weight to the number of active participants and a lesser weight to the number of inactive participants in the group.

In an embodiment, a likeability rating parameter (y) may also dynamically influence floor time by allowing each participant's likeability to be up-voted or down-voted by the others. In an embodiment, the aggregate result of the favorable votes and unfavorable votes (e.g., “up” and “down” votes) received from others in the group communication may provide a net positive or negative likeability rating for each subject participant, which may respectively cause an increase or decrease for that participant's floor time. In an example group communication, each participant might have a likeability rating of zero at the beginning of the call. Alternatively, a participant who has celebrity status or who purchases premium features, such as through a subscription purchase, might be given a higher (i.e., non-zero) baseline likeability rating when the call begins.

In addition, a popularity ranking parameter (z) may be determined based on a participant's overall likeability ratings accumulated from previous group communications. For example, participants who consistently achieve positive aggregate likeability ratings during various group communications may experience an increase in their popularity ratings over time. In some embodiments, participants may pay an additional subscription or one-time amount to achieve a “premium” status with a higher popularity ranking. In various embodiments, unlike active participation and likeability rating parameters, a participant's popularity ranking parameter may be fixed during a group communication, and may be updated at its conclusion.

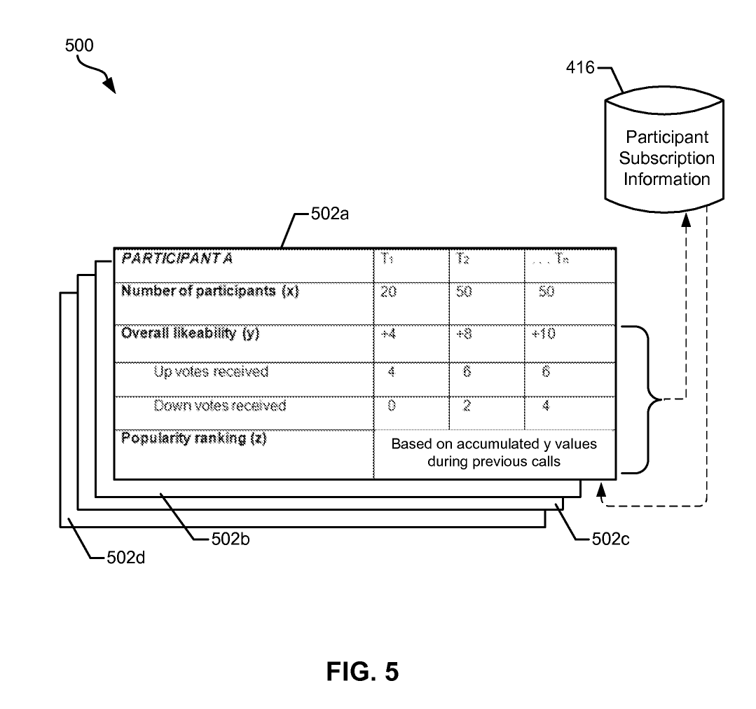

FIG. 5 illustrates an example data structure that may be used to keep track of parameters and other information associated with participants during a group communication 500. In an embodiment, as shown for group communication 500, separate data structures may be maintained for each participant (e.g., table 502a for Participant A). In alternative embodiments, parameter values for all participants may be maintained in a single, group data structure.

In an example embodiment, table 502a may be used to keep track of information associated with Participant A at time intervals during a group communication 500. As shown in a data entry at time T₁ the group communication 500 may have 20 active participants, each of whom may be associated with one of the other tables 502b, 502c, etc. Table 502a also illustrates that Participant A received four favorable votes (“up votes”) and zero unfavorable votes (“down votes”) in time T₁, which may have been received from any of the nineteen other active participants.

In an embodiment, table 502a may be used to compute and track Participant A's overall likeability based on the number of favorable or “up votes” and unfavorable or “down votes” received. For example, table 502a illustrates that at T₁ Participant A had an overall likeability rating of positive four (+4), i.e., the sum of the positive number of favorable or “up” votes (+4) and negative number of unfavorable or “down” votes (−0). In the various embodiments, the group communication server or device may perform ad hoc computations of overall likeability rating for participants, and therefore may record only the overall likeability associated with each participant (e.g., in tables 502a, 502b, etc.). In alternative embodiments, the group communication server may only store the “up” and “down” votes, without computing an overall likeability.

In the illustrated example group communication 500, each likeability vote may be counted equally in determining an overall likeability rating for Participant A, as shown in table 502a. In alternative embodiments, votes received from various other participants in the communication group may receive more or less weight, depending on any of a variety of criteria. For example, likeability votes may be subject to time restrictions such that less weight may be given to up or down votes received near the end of the group communication. In another example, popularity rankings of the voting participant may be used to weight the likeability votes, such as by giving more weight to voting participants with higher popularity rankings. In an embodiment, a voting participant's location may also affect the weight of his or her likeability vote. For example, when a group communication involves a particular live event, the GPS location of a voting participant may be send to a group communication server along with the participant's vote. The group communication server may be configured, in an embodiment, to give more weight to votes from participants who are located in close proximity of the live event that is a subject of the group communication. These weighting factors for participant votes provide only a few examples, as any of a number of other weighting factors may be used instead of or in addition to these examples.

Further, in alternative embodiments, participant voting options may involve selection options with further details beyond “up” and “down” votes, which may also result in different weighting options. For example, a participant may be given the option to vote another participant “up” or “down” by a magnitude factor. For example, a vote received with a minimum magnitude (e.g., “1”) may be given a much lower weight by a group communication server than a vote that received with a maximum magnitude (e.g., “5” or other maximum value).

Returning to FIG. 5, after a time interval has passed, the group communication system may repeat queries involved in updating values for some of the various parameters (e.g., for active participation and likeability rating parameters) associated with Participant A. Updated parameter values, such as an updated group size and an updated likeability rating, may be stored in table 502a. In an example, as shown in table 502a, at time T₂ the number of active participants in the group communication 500 has increased (e.g., from 20 to 50 participants). At time T₂ the system may also determine the total “up” and “down” votes received by Participant A since the beginning of group communication 500, and may store the current totals along with an updated overall likeability rating. For example, since T₁ Participant A may have received two additional up votes, as well as 2 down votes, and therefore may have a current total of six up votes and two down votes (as shown in table 502a).

In the example equally-weighted voting system, the sum of the positive number of favorable/up votes and the negative number of unfavorable/down votes may be determined to provide the current overall likeability rating for Participant A (i.e., (+6)+(−2)=(+4)). Thus as shown in Table 502a, an overall likeability rating of positive 4 (+4) may be recorded in an entry at time T₂. The tracking of the number of participants in the group communication 500, and the likeability rating for Participant A, may be repeated until the end of the group communication 500 (i.e., through Tₙ). In some embodiments, time intervals may be regularly occurring periods, with determinations at T₁, T₂ . . . Tₙ being separated by a fixed number of seconds/minutes. In alternative embodiments, time intervals may not be periodic, and may instead occur in response to a talk related threshold or condition. For example, T₁, T₂ . . . Tₙ may correspond to times at which a current speaker in the group communication 500 surrenders the floor, or falls below a predetermined threshold of remaining floor time.

Participant A's popularity ranking may be retrieved from memory, such as the participant subscription information database 412, discussed above with respect to FIG. 4. This parameter value may have been computed based on Participant A's overall likeability ratings accumulated from previous group communications, and which may also have been stored in the participant subscription information database 412. In an embodiment, an index may be maintained for each participant to track the overall likeability rating increase or decrease during completed calls, which may be stored in the participant subscription information database. For example, a participant's overall likeability up-votes and four down-votes in likeability during a group call, when the call is completed, the index for that participant may be increased based on the fact that the likeability rating was positive during the call, and stored in memory for later floor time allocation calculations.

Upon the termination of the group communication 500, tracked parameter values for each participant, such as those shown in table 502a for Participant A, may be uploaded to or stored in the participant subscription information database 412 by the group communication server. In this manner, popularity rankings for a participant may be updated by factoring in the latest likeability entries that were stored. In one embodiment, an index may be maintained for each participant that tracks the overall likeability rating increase or decrease after completed calls, which may also be stored in the participant subscription information database 412 to facilitate updating of participants' popularity rankings. Additionally, despite not receiving a positive likeability rating during a group call, a participant may still be able to increase his or her popularity index in other ways, such as by purchasing premium features, by achieving a celebrity status, making a contribution or paying a fee for more time, etc.

In addition to using a participant's overall likeability accumulated from past communications, updates to a participant's popularity ranking may be based on other information that may be stored for each participant. For example, a participant's subscription status may indicate that a participant has paid for a premium subscription, thereby entitling the participant to an elevated popularity ranking. Further, indications of other statuses such as a celebrity status may serve to increase the participant's popularity.

In the various embodiments, a popularity ranking parameter, as well as initial and updated values for number of active participants and overall likeability parameters during the group communication 500, may be used by the system to implement a floor control function to dynamically manage effective floor time allocated to the participants. For example, a group communication server executing the floor control function may use entries from table 502a to adjust Participant A's floor time. In various embodiments, the floor control function may be applied with high relative frequency (i.e., after each time interval T₁, T₂, etc.) or low relative frequency (i.e., after multiple time intervals) during the group communication 500.

Implementing the floor control function may involve applying multiple adjustments to participants' effective floor time. In an embodiment, the adjustments may themselves be functions of the parameter values tracked and updated for each participant during the group communication 500. For example, a size of group adjustment may be computed as a function of the active participation parameter (i.e., ƒ(x)). Further, a likeability adjustment may be computed as a function of the number of the participant's overall likeability (i.e., ƒ(y)). Moreover, a popularity adjustment may be computed as a function of the participant's popularity ranking (i.e., ƒ(z)). In an embodiment, these adjustments may each be given equal weight, while in other embodiments the floor control function may give unequal weight to one or more adjustment.

Regardless of their relative weights, the resulting adjustments may be applied to the participant's effective floor time to compute a total adjustment (i.e., update) to that participant's effective floor time. For example, Participant A may be initially allocated 10 seconds of floor time, and therefore Participant A's updated effective floor time allocation may be computed as: 10 s+[ƒ(x)+ƒ(y)+ƒ(z)]. While in some embodiments the adjustment may be combined to compute the updated effective floor time, such as in this example for Participant A, in other embodiments each adjustment may be applied individually, and may be applied at different times depending on various criteria (e.g., amount of remaining floor time initially allocated to participant, amount of remaining time in the group call, etc.). Further, while simple addition may be used to combine the adjustments in calculating the total adjustment to the participant's floor time (e.g., ƒ(x)+ƒ(y)+ƒ(z)), in other embodiments calculating a total adjustment may involve inputting the adjustment into a separate algorithm (e.g., F{ƒ(x), ƒ(y), ƒ(z)}) that may involve any of a variety of mathematical techniques.

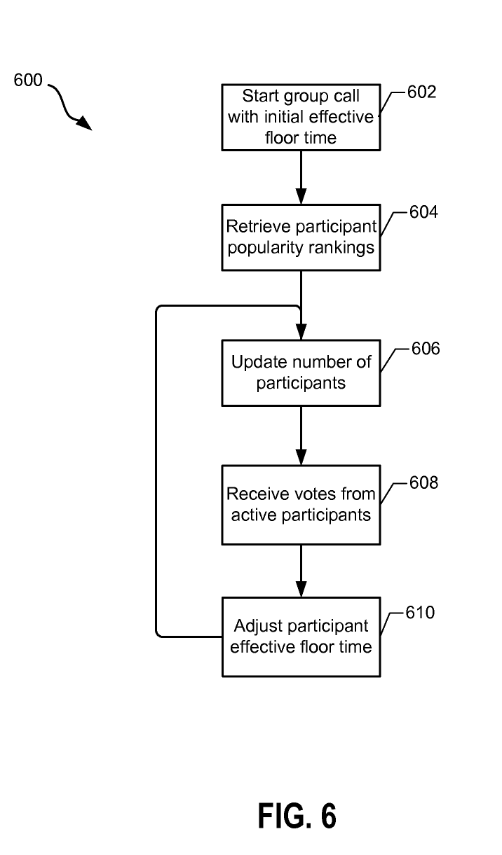

FIG. 6 is a process flow diagram illustrating an embodiment method 600 of adjusting effective floor time for at least one participant during a group communication. The operations of method 600 may be implemented by one or more processors of a group communication server (e.g., processor 404 of group communication server 400) and/or one or more processors of a participant's wireless device (e.g., one of wireless devices 312).

In block 602, a group communication may be started, and each participant may be initially allocated an effective floor time. For example, in a PTT/PTX session, a participant's effective floor time may represent the amount of total time during which the participant may occupy the floor and thus prevent other participants from speaking. As discussed above, such initial effective floor time allocations may be based on the number of active participants initially in the group, and may be either evenly or unevenly distributed among such participants. In alternative embodiments, as also discussed above, initial floor time allocations may be determined based on counting all participants initially in the group communication. Further, the initial effective floor time allocation for all participants in a PTT/PTX session may add up to the total available time, or alternatively may add up to a number that may be less than the total call time, thereby reserving some of the call time for later allocation based on the other parameters. In full-duplex group calls, such as conference calls, the effective floor time might represent the amount of total time during which the participant may be permitted to speak during the conference (i.e., transmit (Tx) enabled), which may be initially set equal to the entire conference time.

In block 604, a processor may retrieve the participants' popularity rankings. As discussed above with respect to FIG. 5, a participant's popularity ranking may be based on the participant's likeability ratings during previous group calls, and may also be influenced by participant purchases, statuses, etc. As further discussed above with reference to FIG. 5, participants' popularity rankings may be tracked and stored in data structures.

In block 606, the processor may update the number of participants (e.g., the number of active participants and/or total number of participants) in the group communication. During the group communication, a participant may up-vote or down-vote other participants to alter their floor time, which may be received by the group communication server in block 608. In block 610 the processor may compute, and apply, an adjustment to at least one participant's effective floor time using the dynamic floor control function discussed above with respect to FIG. 5. The adjusted effective floor time may be computed as a weighted function of the number of participants now in the call, the participant's likeability rating during the call (i.e., from the received votes), and/or the popularity rank of that participant from previous calls, as well as other factors. In an embodiment, implementing the floor control function for a particular participant may include computing an adjustment based on the number of participants in the group communication, an adjustment based on the overall likeability of the particular participants (i.e., based on the cumulative up and down votes received so far relating to the particular participant), and an adjustment based on the particular participant's popularity ranking.

In addition to adjustments based directly on the floor control function, a participant's effective floor time may be adjusted as a result of an adjustment to another participant's floor time. For example, in a PTT/PTX session in which all of call time may be distributed to participants during the initial effective floor time allocation, any adjustment to a participant's effective floor time may also affect the floor time allocated to the rest of the group. For example, if Participant B's floor time increases based on the floor grant function, additional time for Participant B may be taken from the floor time allocated to the other participants (unless the floor control function determines that another participant's floor time should be decreased by at least as much time). In this manner, Participant A's floor time may be adjusted down based on the floor control function's result for Participant B.

The processor may return to block 606 and may repeat blocks 606 through 610 until the group communication ends, thereby enabling the allocations to dynamically update and account for various changes that may occur within the group communication (e.g., sudden change in conversation topic, a participant's comment that may be viewed as strongly favorable or unfavorable, etc.). In an embodiment, repeating these updates may occur after a fixed or variable time interval. Once the call ends, each participants' popularity ranking may be updated as appropriate for use in allocating talk time in future calls.

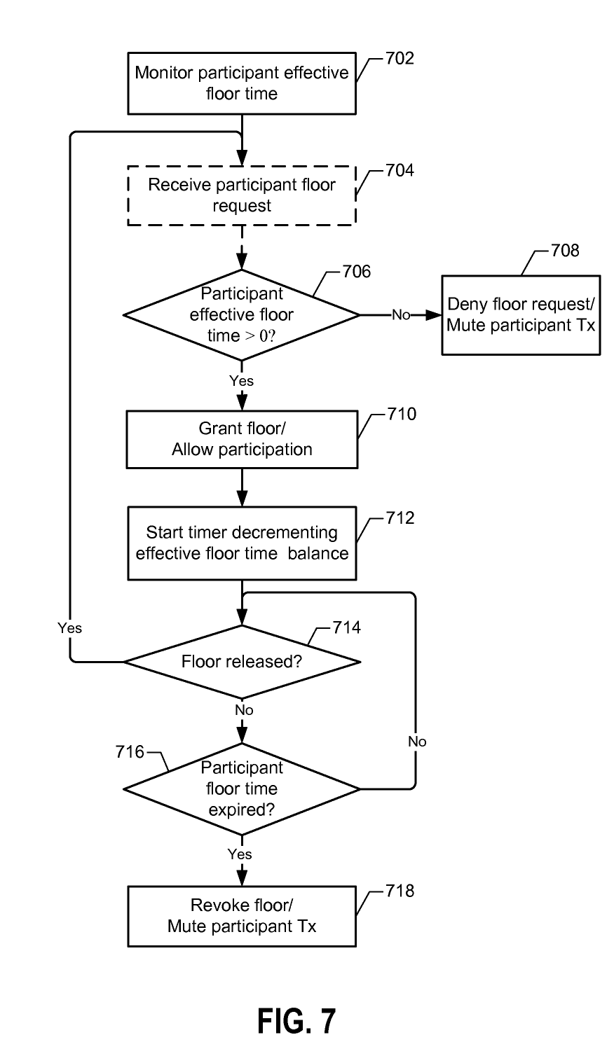

FIG. 7 is a process flow diagram illustrating an embodiment method 700 of controlling the floor based on the amount of effective floor time allocated to a participant. The operations of method 700 may be implemented by one or more processors of the group communication server, and/or one or more processors of a participant's wireless device. In block 702, a processor may monitor a participant's effective floor time during the group communication. In optional block 704, a floor request may be received from a participant. For example, the group communication may be of a type that requires an explicit floor grant in order for a participant to be able to speak (e.g., PTT/PTX call, etc.).

In determination block 706, the processor may determine whether the requesting participant's effective floor time, as adjusted by the floor control function in FIG. 6, is greater than zero. If the requesting participant's adjusted effective floor time is not greater than zero (i.e., determination block 706=“No”), in block 708 the processor may deny the participant's floor request, or alternatively, may remove or lower the Tx capability on the participant's connection in the group call. This second action may be useful, for example, in a full-duplex conference call in which background noise or feedback from a participant's device occurs. In such a scenario, down-voting a participant's likeability may result in attenuating that participant's RTP stream such that the participant may no longer be heard in the communication. Alternatively, such a participant may be muted or diminished at the source (i.e., wireless device 312). For example, the wireless device 312 may receive a signal from the group communication server acting on the microphone resource hardware or software on the participant's wireless device 312. Down-voting a participant's likeability may result, alternatively or additionally, in selectively increasing the Tx capability of all of the other active participants in the group communication, thereby effectively decreasing the strength of the participant's ability to participate by comparison.

If the participant's adjusted effective floor time exceeds zero (i.e., determination block 706=“Yes”), the floor may be granted to the participant, block 710. In block 712, a timer may be started to count down the participant's remaining effective floor time. The timer countdown may be implemented for all participants by the group communication server, or by each participant on the participant's device.

In determination block 714, the processor may determine whether the participant has released the floor (i.e., in a PTT/PTX call) or has stopped talking (i.e., in a conference call). If the participant has released the floor or stopped talking (i.e., determination block 714=“Yes”), the timer may stop running and the processor may return to block 604 to repeat once the participant requests the floor or begins speaking again. If the participant has not released the floor/stopped talked (i.e., determination block 714=“No”), in determination block 716, the processor may determine whether the participant's floor time has expired by determining whether the timer has reached zero. If the participant's floor time has not expired (i.e., determination block 716=“No”), the processor may return to determination block 714. In an embodiment, other steps may be taken to permit the participant to continue occupying the floor, such as selectively increasing or amplifying the participant's Tx capability and/or selectively suppressing or attenuating the Tx capability of other active participants in the group communication.

If the participant's floor time has expired (i.e., determination block 716=“Yes”), the processor may terminate (i.e., revoke) that participant's floor grant (or mute that participant's phone in a full duplex call). The method 700 may be repeated multiple times throughout the call, so that if a participant who was out of time at one point has been up voted (as in FIG. 5), that participant may receive more time, and thus be permitted to speak the next time he/she requests the floor, and/or have the Tx level returned to normal in a full duplex call.

In the various embodiments, participant votes may be entered and communicated to a group communication server in a number of ways. For example, participant voting may be performed through a user interface on a wireless device, or via another interface, such as a web portal accessed via a computer).

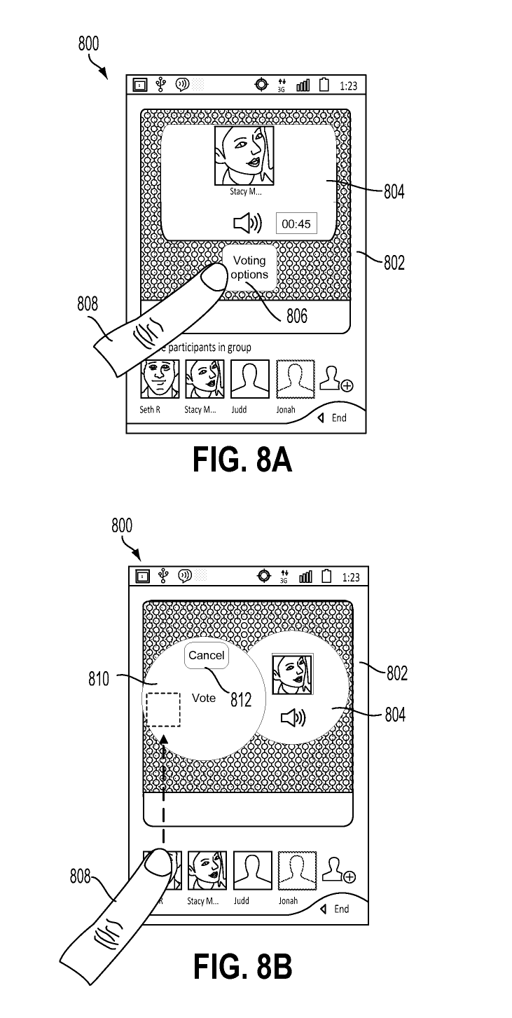

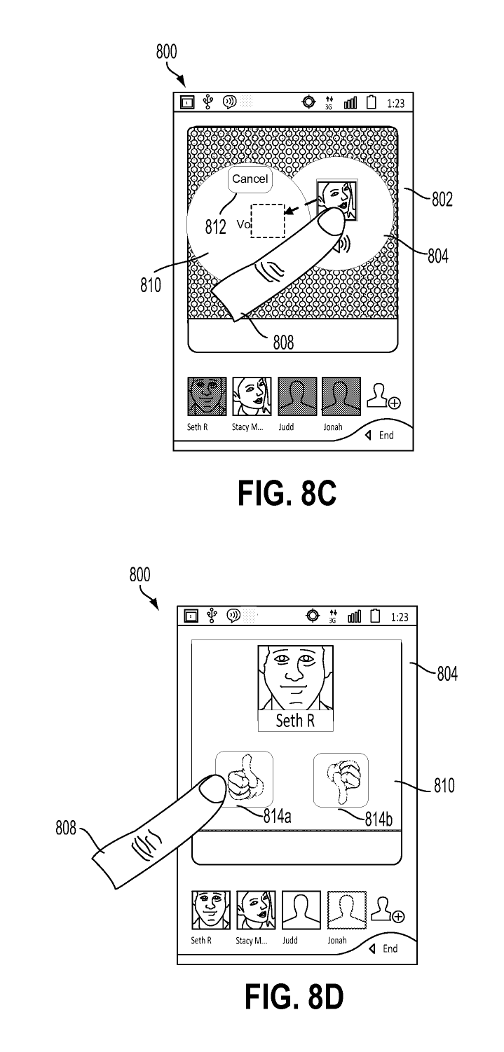

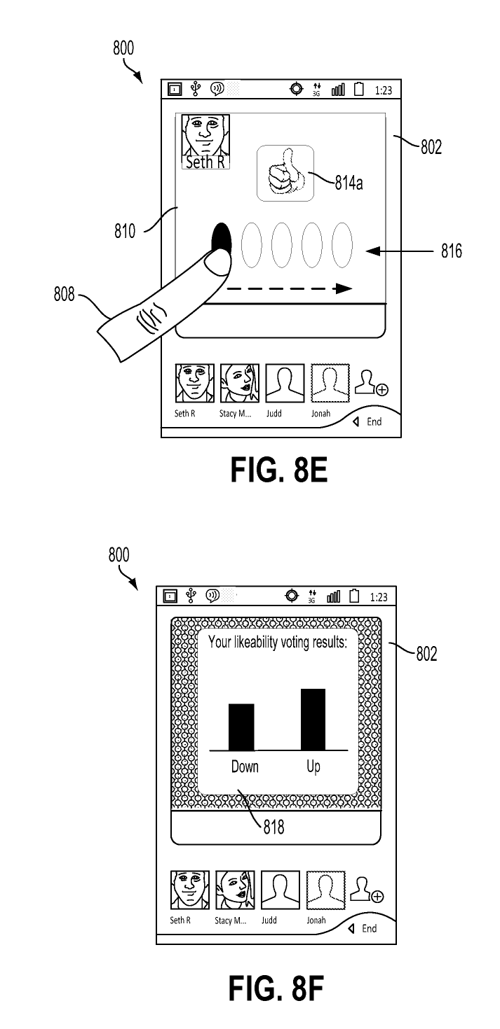

FIGS. 8A-8E are screenshots of a touchscreen display illustrating an embodiment interface for participant voting during an active group communication session. FIG. 8A shows a participant's wireless device during 800 the group communication. Icons and/or text representing the other active participants of the group communication may be displayed along the bottom of the touchscreen display 802, for example. In the various embodiments, the other active participants may be identified on the screen by their names and/or pictures. On the touchscreen display 802, a designated area 804 may identify the current speaker (i.e., participant that holds the floor), along with a measure of the amount of time that he or she has been speaking. A “voting options” softkey 806 may also be displayed on the touchscreen display 802, and may be selectable by the participant touching the screen, for example, using a finger 808, or alternatively, a stylus. Upon selection of the softkey 806, the speaker designated area 804 may shrink, and a new voting area 810 may open on the touchscreen display 802. The participant may indicate a desire to vote for another participant by “dragging” the icon or text representation of that other participant into the voting area 810. A “cancel” softkey 812 may be presented in the voting area 810 which, when selected, may cause removal of the voting area 810 and cause the touchscreen display 802 to return to the display in FIG. 8A.

In some embodiments, the participant may vote up or down for any of the other participants in the group, regardless of the current speaker. For example, in FIG. 8B, the participant may choose to vote for Seth R. by using a finger 808 to drag the corresponding icon from the bottom of the touchscreen display 802 to the voting area 810, even when the current speaker is Stacey M. In other embodiments, participant voting may be restricted to voting up or down for only the current speaker. For example, in FIG. 8C, the participant may only be able to drag the corresponding icon for Stacey M. into the voting area 810, either from the speaker designated area 804 or from the bottom of the touchscreen display 802. In this embodiment, for example, the icons representing the other group participants on the bottom of the touchscreen display 802 may be grayed-out to indicate that they may not be selected for voting.

In FIG. 8D, once the participant has selected another participant to be the subject of voting up or down, the voting area 810 may be expanded to show the subject of the voting, along with voting softkeys 814a, 814b. In an embodiment, each voting softkey may have an icon or text to indicate a vote up or down for the subject of the voting (e.g., Seth R.). Upon selection, the participant's vote may be sent to the group communication server, such as in a RTP control message, with an identifier of the participant to whom the vote pertains.

In another example, the voting options may provide more details beyond just up or down, such as allowing the participant to pair the “up” or “down” vote with a magnitude (e.g., “5” for the strongest vote of like or dislike, and “1” for the mildest vote). In a further example, a slider user interface icon may be provided that a user can slide up or down to reflect a relative favorable/unfavorable rating.

FIG. 8E illustrates a further screen for this enhanced voting option upon selection of one of voting softkeys 814a, 814b. For example, if the participant has selected the voting softkey 814a to vote up for the voting subject Seth R., the icon representing Seth R. may be minimized in the voting area 810, and an icon representing the participant's selection of the softkey 814a may be displayed in voting area 810. A magnitude scale 816 with a plurality of selectable increments may be presented to allow the participant to select a degree of the vote up for Seth R. Such selection may be implemented using the participant's finger 808 to “swipe” over a desired number of increments. For example, the participant may choose to vote up by a small degree by selecting only one of increments, or may choose to vote up by a large degree by selecting four or five of the increments.

In some embodiments, the group communication server may send each participant an indication of the likeability votes pertaining to that participant that were received from the other participants during a recent group communication. In another embodiment, such information may be provided to the participant only upon a sent from the wireless device 312 to the group communication server. As illustrated in FIG. 8F, voting results 818 may be displayed to the participant on the touchscreen display 802 of wireless device 800. In various embodiments, voting results 818 may provide a relative number of votes “up” and “down” pertaining to the participant. In other embodiments, the voting results 818 may include further details, such as comparisons to past results.

The touchscreen display 802 of the wireless device 800 illustrates only one of many different example user interfaces that may be implemented in the various embodiments. Further, the configuration and layout of icons and other graphical elements are provided merely as example designs, and are not intended to limit the embodiment user interfaces.

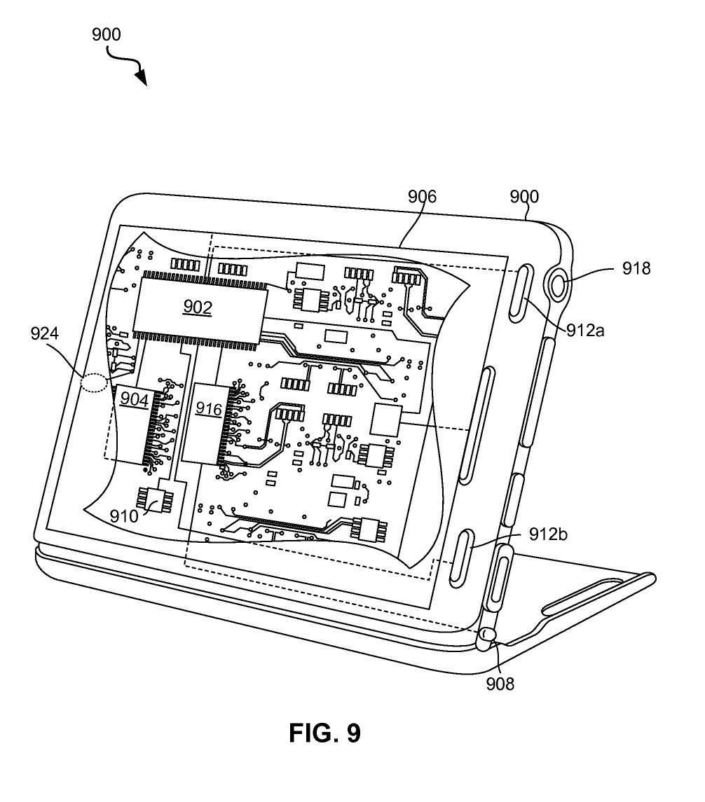

The various embodiments may be implemented in any of a variety of mobile devices, an example of which is illustrated in FIG. 9. For example, the mobile device 900 may include a processor 902 coupled to internal memories 904 and 910. Internal memories 904 and 910 may be volatile or non-volatile memories, and may also be secure and/or encrypted memories, or unsecure and/or unencrypted memories, or any combination thereof. The processor 902 may also be coupled to a touch screen display 906, such as a resistive-sensing touch screen, capacitive-sensing touch screen infrared sensing touch screen, or the like. Additionally, the display of the mobile device 900 need not have touch screen capability. Additionally, the mobile device 900 may have one or more antenna 908 for sending and receiving electromagnetic radiation that may be connected to a wireless data link and/or cellular telephone transceiver 916 coupled to the processor 902. The mobile device 900 may also include physical buttons 912a and 912b for receiving user inputs. The mobile device 900 may also include a power button 918 for turning the mobile device 900 on and off.

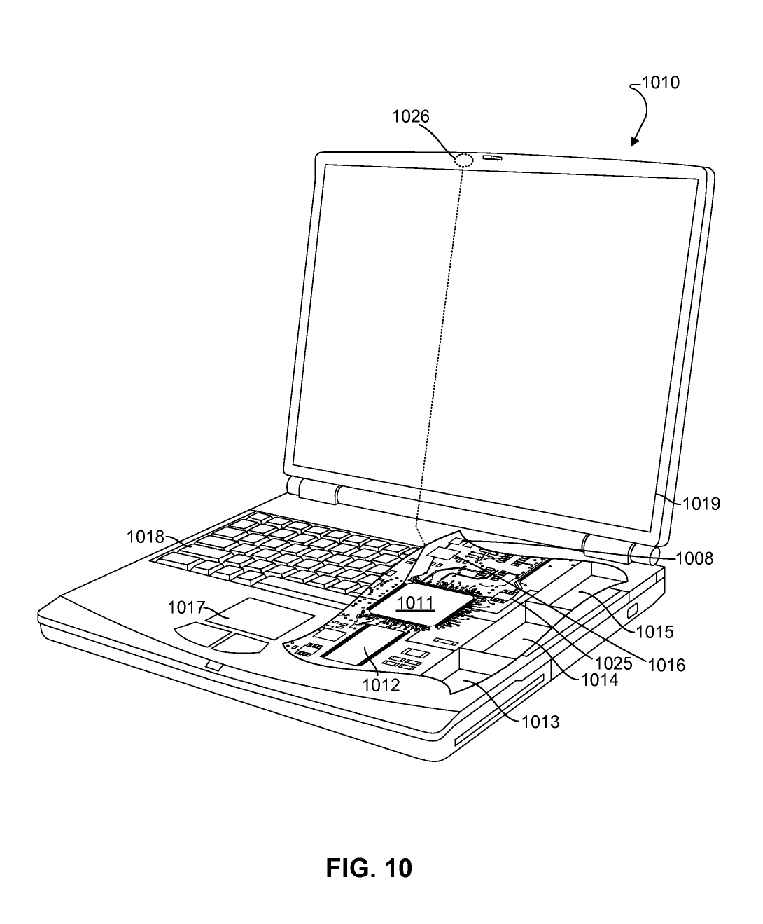

The various embodiments described above may also be implemented within a variety of personal computing devices, such as a laptop computer 1010 as illustrated in FIG. 10. Many laptop computers include a touch pad touch surface 1017 that serves as the computer's pointing device, and thus may receive drag, scroll, and flick gestures similar to those implemented on mobile computing devices equipped with a touch screen display and described above. A laptop computer 1010 will typically include a processor 1011 coupled to volatile memory 1012 and a large capacity nonvolatile memory, such as a disk drive 1013 of Flash memory. The computer 1010 may also include a floppy disc drive 1014 and a compact disc (CD) drive 1015 coupled to the processor 1011. The computer 1010 may also include a number of connector ports coupled to the processor 1011 for establishing data connections or receiving external memory devices, such as a USB or FireWire® connector sockets, or other network connection circuits for coupling the processor 1011 to a network. In a notebook configuration, the computer housing includes the touchpad 1017, the keyboard 1018, and the display 1019 all coupled to the processor 1011. Other configurations of the computing device may include a computer mouse or trackball coupled to the processor (e.g., via a USB input) as are well known, which may also be use in conjunction with the various embodiments.

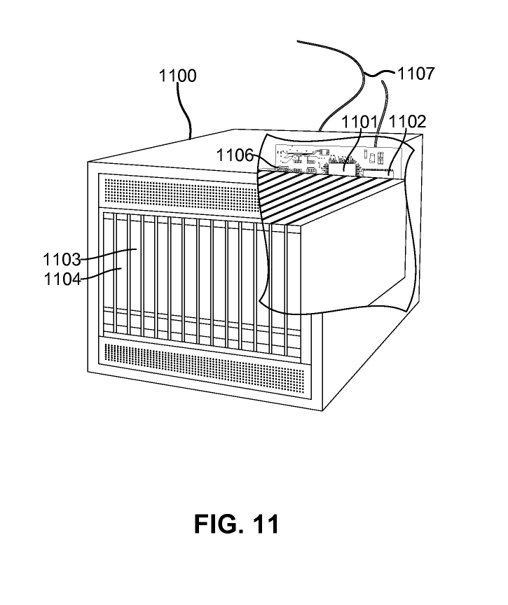

The various embodiments may also be implemented on any of a variety of commercially available server mobile devices, such as the server 1100 illustrated in FIG. 11. Such a server 1100 typically includes a processor 1101 coupled to volatile memory 1102 and a large capacity nonvolatile memory, such as a disk drive 1103. The server 1100 may also include a floppy disc drive, compact disc (CD) or DVD disc drive 1104 coupled to the processor 1101. The server 1100 may also include network access ports 1106 coupled to the processor 1101 for establishing network interface connections with a network 1307, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

The processors 902, 1011, and 1101 may be any programmable microprocessor, microcomputer or multiple processor chip or chips that can be configured by software instructions (applications) to perform a variety of functions, including the functions of the various embodiments described above. In some mobile devices, multiple processors may be provided, such as one processor dedicated to wireless communication functions and one processor dedicated to running other applications. Typically, software applications may be stored in the internal memory 904, 910, 1012, 1013, 1102, 1103 before they are accessed and loaded into the processors 902, 1011, and 1101. The processors 902, 1011, and 1101 may include internal memory sufficient to store the application software instructions. In many mobile devices the internal memory may be a volatile or nonvolatile memory, such as flash memory, or a mixture of both. For the purposes of this description, a general reference to memory refers to memory accessible by the processors 902, 1011, and 1101 including internal memory or removable memory plugged into the mobile device and memory within the processor 902, 1011, and 1101 themselves.

As mentioned above, the references to PTT/PTX communications networks in the foregoing descriptions of the embodiments are for illustrative purposes and are not intended to limit the scope of the claims to a particular group communication technology. The various embodiments are generally applicable to any group communication-capable mobile device and VoIP network, and the forgoing references to PTT/PTX are not intended to limit the scope of the claims unless PTT/PTX technology is expressly recited in the claims.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more embodiments, the functions described may be implemented in hardware, software, firmware, or any combination thereof. If implemented in software, the functions may be stored on as one or more instructions or code on a non-transitory computer-readable storage medium. The steps of a method or algorithm disclosed herein may be embodied in a processor-executable software module which may reside or be stored on a non-transitory computer-readable storage medium or processor-readable medium. Non-transitory computer-readable and processor-readable storage media may be any available media that may be accessed by a computer or processor. By way of example, and not limitation, such non-transitory computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the scope of the invention. Thus, the present invention is not intended to be limited to the embodiments shown herein but is to be accorded the widest scope consistent with the principles and novel features disclosed herein.

What is claimed is:

1. A method of arbitrating floor control between a plurality of active participants in a group communication, comprising:
allocating an initial floor time to each active participant in the plurality of active participants;
determining a group size for the group communication;
determining a likeability rating for at least one active participant of the plurality of active participants; and
adjusting the floor time allocated to the at least one active participant based on the determined group size and the determined likeability rating.

2. The method of claim 1, wherein the group size comprises a count of all participants in the group communication.

3. The method of claim 1, wherein determining the group size comprises counting the plurality of active participants in the group communication.

4. The method of claim 1, wherein adjusting the floor time allocated to the at least one active participant based on the determined group size comprises applying a size function to the floor time allocated to the at least one active participant, wherein the size function is based on a weighted count of the plurality of active participants compared to a count of all participants in the group communication.

5. The method of claim 1, wherein determining the likeability rating for the at least one active participant comprises:
receiving from at least one other active participant a favorable or unfavorable vote regarding the at least one active participant;
determining an aggregate result of all received favorable and unfavorable votes; and
determining a likeability adjustment based on the aggregate result.

6. The method of claim 5, wherein a favorable vote comprises an “up” vote and an unfavorable vote comprises a “down” vote, and wherein determining an aggregate result of all received favorable and unfavorable votes comprises comparing a number of received “up” votes to a number of received “down” votes associated with the at least one active participant.

7. The method of claim 5, wherein adjusting the floor time allocated to the at least one active participant based on the determined likeability rating comprises applying the determined likeability adjustment to the initial floor time allocated to the at least one active participant.

8. The method of claim 1, further comprising retrieving a popularity ranking associated with the at least one active participant, wherein:
the popularity ranking is based on accumulated likeability ratings for the at least one active participant from previous group communications; and
adjusting the floor time allocated to the at least one active participant is further based on the retrieved popularity ranking.

9. The method of claim 8, wherein retrieving a popularity ranking associated with the at least one active participant comprises retrieving participant subscription information from a database.

10. The method of claim 8, wherein the retrieved popularity ranking is further based on a subscription purchase by the at least one participant, wherein the popularity ranking is increased in response to the subscription purchase by the at least one participant.

11. The method of claim 8, wherein the determined group size, the determined likeability rating, and the retrieved popularity ranking are given equal weight in adjusting the floor time allocated to the at least one active participant.

12. The method of claim 8, wherein the determined group size, the determined likeability rating, and the retrieved popularity ranking are given unequal weight in adjusting the floor time allocated to the at least one active participant.

13. The method of claim 5, further comprising assigning a weight to each received favorable or unfavorable vote, wherein determining a likeability adjustment further comprises applying to the votes the respectively assigned weights.

14. The method of claim 5, wherein received favorable and unfavorable votes include a magnitude factor, wherein determining an aggregate result of all received favorable and unfavorable votes is based on the received magnitude factors.

15. The method of claim 5, further comprising updating the floor time allocated to the at least one active participant, comprising:
updating the group size of the group communication;
updating a likeability rating for at least one active participant using favorable and unfavorable votes received for the at least one active participant received since a previous floor time adjustment; and
updating the floor time allocated to the at least one active participant based on the updated group size and the updated likeability rating.

16. The method of claim 1, further comprising:
determining whether the adjusted floor time allocated to the at least one active participant is greater than zero;
determining whether the at least one active participant is presently speaking in response to determining that the adjusted floor time allocated to the at least one active participant is greater than zero; and
starting a countdown of the adjusted floor time allocated to the at least one active participant in response to determining that the at least one active participant is presently speaking.

17. The method of claim 16, further comprising increasing the transmit capability of at least one other active participant in response to determining that the adjusted floor time allocated to the at least one active participant is greater than zero.

18. The method of claim 16, further comprising selectively diminishing the transmit capability of at least one other active participant in response to determining that the adjusted floor time allocated to the at least one active participant is greater than zero.

19. The method of claim 18, further comprising selectively increasing the transmit capability of the at least one active participant in response to determining that the adjusted floor time allocated to the at least one active participant is greater than zero.

20. The method of claim 16, further comprising muting a transmit capability of the at least one active participant in response to determining that the adjusted floor time is not greater than zero.

21. The method of claim 14, further comprising revoking a floor granted to the at least one active participant in response to determining that the adjusted floor time is not greater than zero.

22. The method of claim 16, further comprising:
receiving Real-time Transport Protocol (RTP) streams from the plurality of active participants; and
mixing the received RTP streams to generate a new RTP stream for distributing to participants in the group communication,
wherein mixing the received RTP streams comprises selectively diminishing an RTP stream received from the at least one active participant in response to determining that the adjusted floor time is not greater than zero.

23. The method of claim 1, further comprising:
receiving from at least one other participant a favorable or unfavorable vote regarding the at least one active participant, wherein a favorable vote provides an amount of time by which to increase the floor time allocated to the at least one active participant, and wherein an unfavorable vote indicates an amount of time by which to decrease the floor time allocated to the at least one participant;
determining an aggregate change in floor time allocated to the at least one active participant by combining the amounts of increase time and decrease time indicated in all of the received favorable and unfavorable votes; and
adjusting the floor time allocated to the at least one active participant based on the aggregate change in floor time.

24. The method of claim 23, wherein a sum of the initial floor times allocated to each active participant comprises a total amount of time for the group communication.

25. The method of claim 24, wherein the amount of time provided in a favorable vote represents time presently allocated to the at least one other participant.

26. The method of claim 23, wherein a sum of the initial floor times allocated to each active participant is less than a total amount of time for the group communication, wherein a difference between the sum and the total amount of time for the group communication is allocated to a global floor time bank assigned to the group communication.

27. The method of claim 23, wherein the amount of time provided in a favorable vote represents time presently allocated to the global floor time bank, and wherein the amount of time provided in an unfavorable vote represents time to be transferred to the global floor time bank from the at least one active participant.

28. A group communication server, comprising:
a memory;
a network interface; and
a processor coupled to the memory and the network interface, and configured with processor-executable instructions to perform operations comprising:
allocating an initial floor time to each active participant in a plurality of active participants in a group communication;
determining a group size for the group communication;
determining a likeability rating for at least one active participant of the plurality of active participants; and
adjusting the floor time allocated to the at least one active participant based on the determined group size and the determined likeability rating.

29. The group communication server of claim 28, wherein the processor is configured with processor-executable instructions to perform operations such that determining the group size for the group communication comprises counting all participants in the group communication.

30. The group communication server of claim 28, wherein the processor is configured with processor-executable instructions to perform operations such that determining the group size comprises counting the plurality of active participants in the group communication.

31. The group communication server of claim 28, wherein the processor is configured with processor-executable instructions to perform operations such that adjusting the floor time allocated to the at least one active participant based on the determined group size comprises applying a size function to the floor time allocated to the at least one active participant, wherein the size function is based on a weighted count of the plurality of active participants compared to a count of all participants in the group communication.

32. The group communication server of claim 28, wherein the processor is configured with processor-executable instructions to perform operations such that determining the likeability rating for the at least one active participant comprises:
receiving from at least one other active participant a favorable or unfavorable vote regarding the at least one active participant;
determining an aggregate result of all received favorable and unfavorable votes; and
determining a likeability adjustment based on the aggregate result.

33. The group communication server of claim 32, wherein the processor is configured with processor-executable instructions to perform operations such that:
a favorable vote comprises an “up” vote and an unfavorable vote comprises a “down” vote; and
determining an aggregate result of all received favorable and unfavorable votes comprises comparing a number of received “up” votes to a number of received “down” votes associated with the at least one active participant.

34. The group communication server of claim 32, wherein the processor is configured with processor-executable instructions to perform operations such that adjusting the floor time allocated to the at least one active participant based on the determined likeability rating comprises applying the determined likeability adjustment to the initial floor time allocated to the at least one active participant.

35. The group communication server of claim 28, wherein the processor is configured with processor-executable instructions to perform operations further comprising retrieving a popularity ranking associated with the at least one active participant, and wherein the processor is configured with processor-executable instructions to perform operations such that:
the popularity ranking is based on accumulated likeability ratings for the at least one active participant from previous group communications; and
adjusting the floor time allocated to the at least one active participant is further based on the retrieved popularity ranking.

36. The group communication server of claim 35, wherein the processor is configured with processor-executable instructions to perform operations such that retrieving a popularity ranking associated with the at least one active participant comprises retrieving participant subscription information from a database.

37. The group communication server of claim 35, wherein the processor is configured with processor-executable instructions to perform operations such that the retrieved popularity ranking is further based on a subscription purchase by the at least one participant, and the popularity ranking is increased in response to the subscription purchase by the at least one participant.

38. The group communication server of claim 35, wherein the processor is configured with processor-executable instructions to perform operations such that the determined group size, the determined likeability rating, and the retrieved popularity ranking are given equal weight in adjusting the floor time allocated to the at least one active participant.

39. The group communication server of claim 35, wherein the processor is configured with processor-executable instructions to perform operations such that the determined group size, the determined likeability rating, and the retrieved popularity ranking are given unequal weight in adjusting the floor time allocated to the at least one active participant.

40. The group communication server of claim 32, wherein:
the processor is configured with processor-executable instructions to perform operations further comprising assigning a weight to each received favorable or unfavorable vote; and
the processor is configured with processor-executable instructions to perform operations such that determining a likeability adjustment further comprises applying to the votes the respectively assigned weights.

41. The group communication server of claim 32, wherein the processor is configured with processor-executable instructions such that the received favorable and unfavorable votes include a magnitude factor, and determining an aggregate result of all received favorable and unfavorable votes is based on the received magnitude factors.

42. The group communication server of claim 32, wherein:
the processor is configured with processor-executable instructions, further comprising updating the floor time allocated to the at least one active participant; and
the processor is configured with processor-executable instructions to perform operations such that updating the floor time allocated to the at least one active participant comprises:
updating the group size of the group communication;
updating a likeability rating for at least one active participant using favorable and unfavorable votes received for the at least one active participant received since a previous floor time adjustment; and
updating the floor time allocated to the at least one active participant based on the updated group size and the updated likeability rating.

43. The group communication server of claim 28, wherein the processor is configured with processor-executable instructions to perform operations further comprising:
determining whether the adjusted floor time allocated to the at least one active participant is greater than zero;
determining whether the at least one active participant is presently speaking in response to determining that the adjusted floor time allocated to the at least one active participant is greater than zero; and
starting a countdown of the adjusted floor time allocated to the at least one active participant in response to determining that the at least one active participant is presently speaking.

44. The group communication server of claim 43, wherein the processor is configured with processor-executable instructions to perform operations further comprising increasing the transmit capability of at least one other active participant in response to determining that the adjusted floor time allocated to the at least one active participant is greater than zero.

45. The group communication server of claim 43, wherein the processor is configured with processor-executable instructions to perform operations further comprising selectively diminishing the transmit capability of at least one other active participant in response to determining that the adjusted floor time allocated to the at least one active participant is greater than zero.

46. The group communication server of claim 45, wherein the processor is configured with processor-executable instructions to perform operations further comprising selectively increasing the transmit capability of the at least one active participant in response to determining that the adjusted floor time allocated to the at least one active participant is greater than zero.

47. The group communication server of claim 45, wherein the processor is configured with processor-executable instructions to perform operations further comprising muting a transmit capability of the at least one active participant in response to determining that the adjusted floor time is not greater than zero.

48. The group communication server of claim 41, wherein the processor is configured with processor-executable instructions to perform operations further comprising revoking a floor granted to the at least one active participant in response to determining that the adjusted floor time is not greater than zero.

49. The group communication server of claim 43, wherein:
the processor is configured with processor-executable instructions to perform operations further comprising:
receiving Real-time Transport Protocol (RTP) streams from the plurality of active participants; and
mixing the received RTP streams to generate a new RTP stream for distributing to participants in the group communication; and
the processor is configured with processor-executable instructions to perform operations such that mixing the received RTP streams comprises selectively diminishing an RTP stream received from the at least one active participant in response to determining that the adjusted floor time is not greater than zero.

50. The group communication server of claim 28, wherein the processor is configured with processor-executable instructions to perform operations further comprising:
receiving from at least one other participant a favorable or unfavorable vote regarding the at least one active participant, wherein a favorable vote provides an amount of time by which to increase the floor time allocated to the at least one active participant, and wherein an unfavorable vote indicates an amount of time by which to decrease the floor time allocated to the at least one participant;
determining an aggregate change in floor time allocated to the at least one active participant by combining the amounts of increase time and decrease time indicated in all of the received favorable and unfavorable votes; and
adjusting the floor time allocated to the at least one active participant based on the aggregate change in floor time.

51. The group communication server of claim 50, wherein the processor is configured with processor-executable instructions such that a sum of the initial floor times allocated to each active participant comprises a total amount of time for the group communication.

52. A group communication server, comprising:
means for allocating an initial floor time to each active participant in a plurality of active participants in a group communication;
means for determining a group size for the group communication;
means for determining a likeability rating for at least one active participant of the plurality of active participants; and
means for adjusting the floor time allocated to the at least one active participant based on the determined group size and the determined likeability rating.

53. The group communication server of claim 52, wherein the group size comprises a count of all participants in the group communication.

54. The group communication server of claim 52, wherein means for determining the group size comprises means for counting the plurality of active participants in the group communication.

55. The group communication server of claim 52, wherein means for adjusting the floor time allocated to the at least one active participant based on the determined group size comprises means for applying a size function to the floor time allocated to the at least one active participant, wherein the size function is based on a weighted count of the plurality of active participants compared to a count of all participants in the group communication.

56. The group communication server of claim 52, wherein means for determining the likeability rating for the at least one active participant comprises:
means for receiving from at least one other active participant a favorable or unfavorable vote regarding the at least one active participant;
means for determining an aggregate result of all received favorable and unfavorable votes; and
means for determining a likeability adjustment based on the aggregate result.

57. The group communication server of claim 56, wherein a favorable vote comprises an “up” vote and an unfavorable vote comprises a “down” vote, and
wherein means for determining an aggregate result of all received favorable and unfavorable votes comprises means for comparing a number of received “up” votes to a number of received “down” votes associated with the at least one active participant.

58. The group communication server of claim 56, wherein means for adjusting the floor time allocated to the at least one active participant based on the determined likeability rating comprises means for applying the determined likeability adjustment to the initial floor time allocated to the at least one active participant.

59. The group communication server of claim 52, further comprising means for retrieving a popularity ranking associated with the at least one active participant, wherein:
the popularity ranking is based on accumulated likeability ratings for the at least one active participant from previous group communications; and
means for adjusting the floor time allocated to the at least one active participant comprises means for adjusting the floor time allocated to the at least one active participant based on the retrieved popularity ranking.

60. The group communication server of claim 59, wherein means for retrieving a popularity ranking associated with the at least one active participant comprises retrieving participant subscription information from a database.

61. The group communication server of claim 59, further comprising means for increasing the popularity ranking in response to a subscription purchase by the at least one participant.

62. The group communication server of claim 59, wherein the determined group size, the determined likeability rating, and the retrieved popularity ranking are given equal weight in adjusting the floor time allocated to the at least one active participant.

63. The group communication server of claim 59, wherein the determined group size, the determined likeability rating, and the retrieved popularity ranking are given unequal weight in adjusting the floor time allocated to the at least one active participant.

64. The group communication server of claim 56, further comprising means for assigning a weight to each received favorable or unfavorable vote, wherein means for determining a likeability adjustment further comprises means for applying to the votes the respectively assigned weights.

65. The group communication server of claim 56, wherein received favorable and unfavorable votes include a magnitude factor, wherein means for determining an aggregate result of all received favorable and unfavorable votes comprises means for determining an aggregate result of all received favorable and unfavorable votes based on the received magnitude factors.

66. The group communication server of claim 56, further comprising means for updating the floor time allocated to the at least one active participant,
wherein means for updating the floor time allocated to the at least one active participant comprises:
means for updating the group size of the group communication;
means for updating a likeability rating for at least one active participant using favorable and unfavorable votes received for the at least one active participant received since a previous floor time adjustment; and
means for updating the floor time allocated to the at least one active participant based on the updated group size and the updated likeability rating.

67. The group communication server of claim 52, further comprising:
means for determining whether the adjusted floor time allocated to the at least one active participant is greater than zero;
means for determining whether the at least one active participant is presently speaking in response to determining that the adjusted floor time allocated to the at least one active participant is greater than zero; and
means for starting a countdown of the adjusted floor time allocated to the at least one active participant in response to determining that the at least one active participant is presently speaking.

68. The group communication server of claim 67, further comprising means for increasing the transmit capability of at least one other active participant in response to determining that the adjusted floor time allocated to the at least one active participant is greater than zero.

69. The group communication server of claim 67, further comprising means for selectively diminishing the transmit capability of at least one other active participant in response to determining that the adjusted floor time allocated to the at least one active participant is greater than zero.

70. The group communication server of claim 69, further comprising means for selectively increasing the transmit capability of the at least one active participant in response to determining that the adjusted floor time allocated to the at least one active participant is greater than zero.

71. The group communication server of claim 67, further comprising means for muting a transmit capability of the at least one active participant in response to determining that the adjusted floor time is not greater than zero.

72. The group communication server of claim 65, further comprising means for revoking a floor granted to the at least one active participant in response to determining that the adjusted floor time is not greater than zero.

73. The group communication server of claim 67, further comprising:
means for receiving Real-time Transport Protocol (RTP) streams from the plurality of active participants; and
means for mixing the received RTP streams to generate a new RTP stream for distributing to participants in the group communication,
wherein means for mixing the received RTP streams comprises means for selectively diminishing an RTP stream received from the at least one active participant in response to determining that the adjusted floor time is not greater than zero.

74. The group communication server of claim 52, further comprising:
means for receiving from at least one other participant a favorable or unfavorable vote regarding the at least one active participant, wherein a favorable vote provides an amount of time by which to increase the floor time allocated to the at least one active participant, and wherein an unfavorable vote indicates an amount of time by which to decrease the floor time allocated to the at least one participant;
means for determining an aggregate change in floor time allocated to the at least one active participant by combining the amounts of increase time and decrease time indicated in all of the received favorable and unfavorable votes; and
means for adjusting the floor time allocated to the at least one active participant based on the aggregate change in floor time.

75. The group communication server of claim 74, wherein a sum of the initial floor times allocated to each active participant comprises a total amount of time for the group communication.

76. The group communication server of claim 75, wherein the amount of time provided in a favorable vote represents time presently allocated to the at least one other participant.

77. The group communication server of claim 74, wherein a sum of the initial floor times allocated to each active participant is less than a total amount of time for the group communication, wherein a difference between the sum and the total amount of time for the group communication is allocated to a global floor time bank assigned to the group communication.

78. The group communication server of claim 74, wherein the amount of time provided in a favorable vote represents time presently allocated to the global floor time bank, and wherein the amount of time provided in an unfavorable vote represents time to be transferred to the global floor time bank from the at least one active participant.

79. A non-transitory computer-readable medium having stored thereon processor-executable instructions configured to cause a processor of a group communication server to perform operations comprising:
allocating an initial floor time to each active participant in a plurality of active participants in a group communication;
determining a group size for the group communication;
determining a likeability rating for at least one active participant of the plurality of active participants; and
adjusting the floor time allocated to the at least one active participant based on the determined group size and the determined likeability rating.

80. The non-transitory computer-readable medium of claim 79, wherein the stored processor-executable instructions are configured to cause the group communication server processor to perform operations such that the group size comprises a count of all participants in the group communication.

81. The non-transitory computer-readable medium of claim 79, wherein the stored processor-executable instructions are configured to cause the group communication server processor to perform operations such that determining the group size comprises counting the plurality of active participants in the group communication.

82. The non-transitory computer-readable medium of claim 79, wherein the stored processor-executable instructions are configured to cause the group communication server processor to perform operations such that adjusting the floor time allocated to the at least one active participant based on the determined group size comprises applying a size function to the floor time allocated to the at least one active participant, wherein the size function is based on a weighted count of the plurality of active participants compared to a count of all participants in the group communication.

83. The non-transitory computer-readable medium of claim 79, wherein the stored processor-executable instructions are configured to cause the group communication server processor to perform operations such that determining the likeability rating for the at least one active participant comprises:
receiving from at least one other active participant a favorable or unfavorable vote regarding the at least one active participant;
determining an aggregate result of all received favorable and unfavorable votes; and
determining a likeability adjustment based on the aggregate result.

84. The non-transitory computer-readable medium of claim 83, wherein the stored processor-executable instructions are configured to cause the group communication server processor to perform operations such that:
a favorable vote comprises an “up” vote and an unfavorable vote comprises a “down” vote; and
determining an aggregate result of all received favorable and unfavorable votes comprises comparing a number of received “up” votes to a number of received “down” votes associated with the at least one active participant.

85. The non-transitory computer-readable medium of claim 83, wherein the stored processor-executable instructions are configured to cause the group communication server processor to perform operations such that adjusting the floor time allocated to the at least one active participant based on the determined likeability rating comprises applying the determined likeability adjustment to the initial floor time allocated to the at least one active participant.

86. The non-transitory computer-readable medium of claim 79, wherein:
the stored processor-executable instructions are configured to cause the group communication server processor to perform operations further comprising retrieving a popularity ranking associated with the at least one active participant; and
the stored processor-executable instructions are configured to cause the group communication server processor to perform operations such that:
the popularity ranking is based on accumulated likeability ratings for the at least one active participant from previous group communications; and
adjusting the floor time allocated to the at least one active participant is further based on the retrieved popularity ranking.

87. The non-transitory computer-readable medium of claim 86, wherein the stored processor-executable instructions are configured to cause the group communication server processor to perform operations such that retrieving a popularity ranking associated with the at least one active participant comprises retrieving participant subscription information from a database.

88. The non-transitory computer-readable medium of claim 86, wherein the stored processor-executable instructions are configured to cause the group communication server processor to perform operations such that the retrieved popularity ranking is further based on a subscription purchase by the at least one participant, wherein the popularity ranking is increased in response to the subscription purchase by the at least one participant.

89. The non-transitory computer-readable medium of claim 86, wherein the stored processor-executable instructions are configured to cause the group communication server processor to perform operations such that the determined group size, the determined likeability rating, and the retrieved popularity ranking are given equal weight in adjusting the floor time allocated to the at least one active participant.

90. The non-transitory computer-readable medium of claim 86, wherein the stored processor-executable instructions are configured to cause the group communication server processor to perform operations such that the determined group size, the determined likeability rating, and the retrieved popularity ranking are given unequal weight in adjusting the floor time allocated to the at least one active participant.

91. The non-transitory computer-readable medium of claim 83, wherein:
the stored processor-executable instructions are configured to cause the group communication server processor to perform operations further comprising assigning a weight to each received favorable or unfavorable vote; and
the stored processor-executable instructions are configured to cause the group communication server processor to perform operations such that determining a likeability adjustment further comprises applying to the votes the respectively assigned weights.

92. The non-transitory computer-readable medium of claim 83, wherein the stored processor-executable instructions are configured to cause the group communication server processor to perform operations such that:
received favorable and unfavorable votes include a magnitude factor; and
determining an aggregate result of all received favorable and unfavorable votes comprises determining an aggregate result of all received favorable and unfavorable votes based on the received magnitude factors.

93. The non-transitory computer-readable medium of claim 83, wherein:
the stored processor-executable instructions are configured to cause the group communication server processor to perform operations further comprising updating the floor time allocated to the at least one active participant; and
the stored processor-executable instructions are configured to cause the group communication server processor to perform operations such that updating the floor time allocated to the at least one active participant comprises:
updating the group size of the group communication;
updating a likeability rating for at least one active participant using favorable and unfavorable votes received for the at least one active participant received since a previous floor time adjustment; and
updating the floor time allocated to the at least one active participant based on the updated group size and the updated likeability rating.

94. The non-transitory computer-readable medium of claim 79, wherein the stored processor-executable instructions are configured to cause the group communication server processor to perform operations further comprising:
determining whether the adjusted floor time allocated to the at least one active participant is greater than zero;
determining whether the at least one active participant is presently speaking in response to determining that the adjusted floor time allocated to the at least one active participant is greater than zero; and
starting a countdown of the adjusted floor time allocated to the at least one active participant in response to determining that the at least one active participant is presently speaking.

95. The non-transitory computer-readable medium of claim 94, wherein the stored processor-executable instructions are configured to cause the group communication server processor to perform operations further comprising increasing the transmit capability of at least one other active participant in response to determining that the adjusted floor time allocated to the at least one active participant is greater than zero.

96. The non-transitory computer-readable medium of claim 94, wherein the stored processor-executable instructions are configured to cause the group communication server processor to perform operations further comprising selectively diminishing the transmit capability of at least one other active participant in response to determining that the adjusted floor time allocated to the at least one active participant is greater than zero.

97. The non-transitory computer-readable medium of claim 96, wherein the stored processor-executable instructions are configured to cause the group communication server processor to perform operations further comprising selectively increasing the transmit capability of the at least one active participant in response to determining that the adjusted floor time allocated to the at least one active participant is greater than zero.

98. The non-transitory computer-readable medium of claim 94, wherein the stored processor-executable instructions are configured to cause the group communication server processor to perform operations further comprising muting a transmit capability of the at least one active participant in response to determining that the adjusted floor time is not greater than zero.

99. The non-transitory computer-readable medium of claim 92, wherein the stored processor-executable instructions are configured to cause the group communication server processor to perform operations further comprising revoking a floor granted to the at least one active participant in response to determining that the adjusted floor time is not greater than zero.

100. The non-transitory computer-readable medium of claim 94, wherein:
the stored processor-executable instructions are configured to cause the group communication server processor to perform operations further comprising:
receiving Real-time Transport Protocol (RTP) streams from the plurality of active participants; and
mixing the received RTP streams to generate a new RTP stream for distributing to participants in the group communication; and
the stored processor-executable instructions are configured to cause the group communication server processor to perform operations such that mixing the received RTP streams comprises selectively diminishing an RTP stream received from the at least one active participant in response to determining that the adjusted floor time is not greater than zero.

101. The non-transitory computer-readable medium of claim 79, wherein the stored processor-executable instructions are configured to cause the group communication server processor to perform operations further comprising:
receiving from at least one other participant a favorable or unfavorable vote regarding the at least one active participant, wherein a favorable vote provides an amount of time by which to increase the floor time allocated to the at least one active participant, and wherein an unfavorable vote indicates an amount of time by which to decrease the floor time allocated to the at least one participant;
determining an aggregate change in floor time allocated to the at least one active participant by combining the amounts of increase time and decrease time indicated in all of the received favorable and unfavorable votes; and
adjusting the floor time allocated to the at least one active participant based on the aggregate change in floor time.

102. The non-transitory computer-readable medium of claim 101, wherein the stored processor-executable instructions are configured to cause the group communication server processor to perform operations such that a sum of the initial floor times allocated to each active participant comprises a total amount of time for the group communication.

103. The non-transitory computer-readable medium of claim 102, wherein the stored processor-executable instructions are configured to cause the group communication server processor to perform operations such that the amount of time provided in a favorable vote represents time presently allocated to the at least one other participant.

104. The non-transitory computer-readable medium of claim 101, wherein the stored processor-executable instructions are configured to cause the group communication server processor to perform operations such that:
a sum of the initial floor times allocated to each active participant is less than a total amount of time for the group communication; and
a difference between the sum and the total amount of time for the group communication is allocated to a global floor time bank assigned to the group communication.

105. The non-transitory computer-readable medium of claim 101, wherein the stored processor-executable instructions are configured to cause the group communication server processor to perform operations such that:
the amount of time provided in a favorable vote represents time presently allocated to the global floor time bank; and
the amount of time provided in an unfavorable vote represents time to be transferred to the global floor time bank from the at least one active participant.
